(19) United States
(12) Patent Application Publication
(10) Pub. No.: US 2025/0015965 A1
(43) Pub. Date: Jan. 9, 2025

(54) Beam Information Indication Method, Terminal and Network Side Device

(71) Applicant: VIVO MOBILE COMMUNICATION CO., LTD., Dongguan (CN)

(72) Inventors: Yu Yang, Dongguan (CN); Yang Song, Dongguan (CN); Rakesh Tamrakar, Dongguan (CN)

(21) Appl. No.: 18/895,071

(22) Filed: Sep. 24, 2024

Related U.S. Application Data
(63) Continuation of application No. PCT/CN2023/083605, filed on Mar. 24, 2023.

(30) Foreign Application Priority Data
Mar. 24, 2022 (CN) 202210303774.6

(51) Int. Cl. H04L 5/00

(52) U.S. Cl. CPC H04L 5/0094; H04L 5/0048

(57) ABSTRACT

A beam information indication method includes receiving, by a terminal, a first command sent by a network side device, the first command being used to activate or indicate at least one unified transmission configuration indicator TCI state ID; and determining, by the terminal, a unified TCI state of a channel or a reference signal in a component carrier CC group based on the unified TCI state ID. A target unified TCI state ID in the at least one unified TCI state ID is associated with a target channel or a target reference signal in the CC group.

### CROSS-REFERENCE TO RELATED APPLICATIONS

This application is a Bypass Continuation Application of International Patent Application No. PCT/CN2023/083605, filed Mar. 24, 2023, and claims priority to Chinese Patent Application No. 202210303774.6, filed Mar. 24, 2022, the disclosures of which are hereby incorporated by reference in their entireties.

### BACKGROUND OF THE INVENTION

### Field of the Invention

This application relates to the field of communication technologies, and in particular, to a beam information indication method, a terminal and a network side device.

### Description of Related Art

In existing communication protocols, to save overheads of beam indication signaling for various channels and reference signals, a cross-carrier beam update mechanism is introduced, so that it is not necessary to perform beam indication on each channel and reference signal (RS) on each carrier, and a network configures at most two component carrier (CC) lists for a downlink and an uplink by radio resource control (RRC) signaling, and performs simultaneous transmission configuration indicator (TCI) state activation on cells in each list. A new TCI framework is introduced, and may be referred to as a unified TCI framework, that is, a same beam indicated by the network using signaling can be used for multi-channel transmission. The above technologies are all beam information configuration manners in the case of single transmission reception point (TRP) transmission, and beam information in a case of multi-TRP transmission cannot be determined at present.

### SUMMARY OF THE INVENTION

In a first aspect, a beam information indication method is provided, including: receiving, by a terminal, a first command sent by a network side device, the first command being used to activate or indicate at least one unified transmission configuration indicator TCI state identifier (ID); and determining, by the terminal, a unified TCI state of a channel or a reference signal in a component carrier CC group based on the unified TCI state ID.

A target unified TCI state ID in the at least one unified TCI state ID is associated with a target channel or a target reference signal in the CC group.

In a second aspect, a beam information indication apparatus is provided, including:
a first receiving module, configured to receive a first command sent by a network side device, the first command being used to activate or indicate at least one unified transmission configuration indicator TCI state ID; and
a first determining module, configured to determine a unified TCI state of a channel or a reference signal in a component carrier CC group based on the unified TCI state ID.

A target unified TCI state ID in the at least one unified TCI state ID is associated with a target channel or a target reference signal in the CC group.

In a third aspect, a beam information indication method is provided, including:
sending, by a network side device, a first command to a terminal, the first command being used to activate or indicate at least one unified TCI state ID, and the unified TCI state ID being used to determine a TCI state of a channel or a reference signal in a CC group.

A target unified TCI state ID in the at least one unified TCI state ID is associated with a target channel or a target reference signal in the CC group.

In a fourth aspect, a beam information indication apparatus is provided, including:
a first sending module, configured to send a first command to a terminal, the first command being used to activate or indicate at least one unified TCI state ID, and the unified TCI state ID being used to determine a TCI state of a channel or a reference signal in a CC group.

A target unified TCI state ID in the at least one unified TCI state ID is associated with a target channel or a target reference signal in the CC group.

In a fifth aspect, a terminal is provided. The terminal includes a processor and a memory. The memory stores a program or instructions that can be run on the processor, and when the program or instructions are executed by the processor, the steps of the method according to the first aspect are implemented.

In a sixth aspect, a terminal is provided, including a processor and a communication interface. The communication interface is configured to receive a first command sent by a network side device. The first command is used to activate or indicate at least one unified transmission configuration indicator TCI state ID. The processor is configured to determine a unified TCI state of a channel or a reference signal in a component carrier CC group based on the unified TCI state ID. A target unified TCI state ID in the at least one unified TCI state ID is associated with a target channel or a target reference signal in the CC group.

In a seventh aspect, a network side device is provided. The network side device includes a processor and a memory. The memory stores a program or instructions that can be run on the processor, and when the program or instructions are executed by the processor, the steps of the method according to the third aspect are implemented.

In an eighth aspect, a network side device is provided, including a processor and a communication interface. The communication interface is configured to send a first command to a terminal. The first command is used to activate or indicate at least one unified TCI state ID. The unified TCI state ID is used to determine a TCI state of a channel or a reference signal in a CC group.

A target unified TCI state ID in the at least one unified TCI state ID is associated with a target channel or a target reference signal in the CC group.

In a ninth aspect, a communication system is provided, including: A terminal and a network side device. The terminal may be configured to perform the steps of the beam information indication method according to the first aspect. The network side device may be configured to perform the steps of the beam information indication method according to the third aspect.

In a tenth aspect, a non-transitory readable storage medium is provided. The non-transitory readable storage medium stores a program or instructions. When the program or instructions are executed by a processor, the steps of the method according to the first aspect are implemented, or the steps of the method according to the third aspect are implemented.

In an eleventh aspect, a chip is provided. The chip includes a processor and a communication interface. The communication interface is coupled to the processor. The processor is configured to run a program or instructions to implement the method according to the first aspect, or implement the method according to the third aspect.

In a twelfth aspect, a computer program/program product is provided. The computer program/program product is stored in a non-transitory storage medium. The computer program/program product is executed by at least one processor to implement the steps of the beam information indication method according to the first aspect, or implement the steps of the beam information indication method according to the third aspect.

### BRIEF DESCRIPTION OF THE DRAWINGS

FIG. 1 is a block diagram of an applicable wireless communication system according to an embodiment of this application;

FIG. 2 is a first schematic flowchart of a beam information indication method according to an embodiment of this application;

FIG. 3 is a second schematic flowchart of a beam information indication method according to an embodiment of this application;

FIG. 4 is a first schematic flowchart of a beam information indication apparatus according to an embodiment of this application;

FIG. 5 is a second schematic flowchart of a beam information indication apparatus according to an embodiment of this application;

FIG. 6 is a schematic diagram of a structure of a communication device according to an embodiment of this application;

FIG. 7 is a schematic diagram of a structure of a terminal according to an embodiment of this application; and

FIG. 8 is a schematic diagram of a structure of a network side device according to an embodiment of this application.

### DESCRIPTION OF THE INVENTION

The technical solutions in embodiments of this application are clearly described below with reference to the accompanying drawings in the embodiments of this application. Clearly, the described embodiments are some rather than all of the embodiments of this application. Based on the embodiments of this application, all other embodiments obtained by a person of ordinary skill in the art fall within the protection scope of this application.

The terms such as “first” and “second” in the specification and claims of this application are intended to distinguish between similar objects, but are not intended to describe a specific sequence or order. It should be understood that the terms used in such a way may be interchanged under appropriate circumstances so that the embodiments of this application can be implemented in an order other than those illustrated or described herein, the objects distinguished by “first” and “second” are usually of one type, and a quantity of objects is not limited. For example, one or more first objects may be provided. In addition, “and/or” in the specification and the claims indicates at least one of connected objects, and the character “/” generally indicates an “or” relationship between associated objects.

It should be noted that the technologies described in the embodiments of this application are not limited to a (LTE)/LTE-advanced (LTE-A) system, and may be also applied to other wireless communication systems such as code division multiple access (CDMA), time division multiple access (TDMA), frequency division multiple access (FDMA), orthogonal frequency division multiple access (OFDMA), single carrier frequency division multiple access (SC-FDMA) and other systems. The terms “system” and “network” in the embodiments of this application are often used interchangeably, and the described technology can be applied to the systems and radio technologies mentioned above, and can be also applied to other systems and radio technologies. The following description describes a new radio (NR) system for example purposes, and NR terms are used in most of the following descriptions, but these technologies can be also applied to applications other than NR system applications, such as 6th generation (6G) communication systems.

FIG. 1 is a block diagram of an applicable wireless communication system according to an embodiment of this application. The wireless communication system includes a terminal 11 and a network side device 12. The terminal 11 may be a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a household device with a wireless communication function, such as a refrigerator, a television, a washing machine or furniture), a game console, a personal computer (PC), an automated teller machine or a self-service machine or other terminal-side devices. The wearable device includes a smartwatch, a smart band, a smart headset, smart glasses, smart jewelry (a smart bracelet, a smart chain bracelet, a smart ring, a smart necklace, a smart anklet, a smart ankle chain, or the like), a smart wrist strap, a smart garment, or the like. It should be noted that a specific type of the terminal 11 is not limited in the embodiment of this application. The network side device 12 may include an access network device or a core network device, where the access network device may be also referred to as a radio access network device, a radio access network (RAN), a radio access network function or a radio access network unit. The access network device may include a base station, a WLAN access point or a WiFi node, or the like. The base station may be referred to as a Node B, an evolved Node B (eNB), an access point, a base transceiver station (BTS), a radio base station, a radio transceiver, a basic service set (BSS), an extended service set (ESS), a home Node B, a home evolved Node B, a transmission-reception point (TRP) or some other appropriate term in the field. As long as the same technical effect is achieved, the base station is not limited to a specific technical vocabulary. It should be noted that in the embodiment of this application, only a base station in an NR system is described as an example, and a specific type of the base station is not limited.

The concepts used in the embodiment are first explained.

### I. Multi-Carrier Beam Update Mechanism.

A network side device configures at most two CC lists for each of a downlink (DL) and an uplink (UL) through RRC signaling, and there is no overlapping CC between CC lists. CC lists of the DL and the UL are independent of each other. Inter-band CA may be included during configuration of a CC list, that is, CCs on different bands may be included in the CC list.

(1) For the downlink, a network configures CC lists for a UE through RRC parameters “simultaneousTCI-UpdateList1” and “simultaneousTCI-UpdateList2”.

1) TCI state update of a control resource set (CORESET).

The network side device can activate a TCI state by a medium access control (MAC) control element (CE). The MAC CE may include a serving cell ID and a CORESET ID.

2) TCI state update of a physical downlink shared channel (PDSCH).

The network side device can activate a TCI state for the PDSCH by a MAC CE.

The MAC CE may include a serving cell ID and a bandwidth Part (BWP) ID.

(2) For the uplink, the network side device configures at most two CC lists for a UE through RRC parameters “simultaneousSpatial-UpdatedList1” and “simultaneousSpatial-UpdatedList2”, and performs simultaneous spatial relation info activation/update on cells in each list.

1) Spatial relation info activation/update of semi-persistent/aperiodic sounding reference signal (SRS) resources.

When a network uses a MAC CE to indicate a spatial relation for an SRS, the MAC CE includes: a serving cell ID, a BWP ID and an SRS resource ID of a semi-persistent SRS (SP-SRS)/aperiodic SRS (AP-SRS) resource, and further includes RS resource information for indicating an SRS spatial relation.

### II. Multi-TRP Scenario.

Control signaling in a multi-TRP scenario includes: single downlink control information (DCI) scheduling and multi-DCI scheduling.

Multi-DCI (mDCI) scheduling: Each TRP sends its own physical downlink control channel (PDCCH), and each PDCCH schedules its own PDSCH.

Single DCI (sDCI) scheduling: A TRP sends a PDCCH to schedule a PDSCH. III.

Unified TCI framework.

The unified TCI framework, that is, a same beam indicated by the network using a MAC CE and/or a DCI, can be used for multi-channel transmission, and this beam may be also referred to as a common beam.

(1) The unified TCI framework includes two modes: a joint TCI and a separate TCI, which are configured by RRC signaling of the network side device.

(2) The network side device configures a TCI state pool through RRC signaling. A joint TCI and a separate DL TCI share a same pool, and a separate UL TCI uses an independently configured pool, and activates one or more TCI states through a MAC CE command.

(3) When using a DCI for beam indication, the network side device supports a DCI format with downlink assignment (DCI formats 1_1/1_2 with DL assignment) and a DCI format without downlink assignment (DCI format 1_1/1_2 without DL assignment).

(4) Target signal of a TCI state (that is, signal applying the TCI state).

DL: UE-dedicated reception on PDSCH, UE-dedicated reception on all or subset of CORESETs, aperiodic CSI-RS resources for channel state information (CSI), aperiodic CSI-RS resources for beam management (BM), and demodulation reference signal(s) (DMRS(s)) associated with non-UE-dedicated reception on CORESET(s) and the associated PDSCH (associated with the serving cell PCI).

UL: Dynamic-grant/configured-grant based PUSCH, all of dedicated PUCCH resources, aperiodic SRS resources or resource sets for BM, SRS for antenna switching, SRS for codebook and SRS for non-codebook.

### IV. Carrier Aggregation (CA) Scenario in the Unified TCI Framework.

### (1) Quantity of CC Lists.

Configuration information of a cell group includes CC lists, and at most four CC lists can be configured. The maximum quantity of CC lists conforms to the UE capability.

### (2) TCI State Pool of CA.

The network side device configures TCI state pool(s) through RRC signaling.

### (3) Quasi Co-Location (QCL) Information.

1) For QCL-TypeA, a source RS and a target channel or RS are located on a same CC.

2) For QCL-TypeD, a source RS may be configured on a target CC or another CC. For example, a QCL-TypeD source RS may be:
one source RS across CCs; or
one source RS per CC, where the source RSs of these carriers are further associated with a same QCL-TypeD RS.

It should be noted that beam information in this application may include at least one of the following information contents: beam identification information, spatial relation information, spatial domain transmission filter information, spatial domain reception filter information, spatial filter information, transmission configuration indicator state information, QCL information, a QCL parameter, or the like.

Downlink beam information can usually be indicated by the TCI state information or the QCL information. Uplink beam information can usually be indicated by the TCI state information or the spatial relation information. That is, the TCI state information can be used to indicate the above beam information.

A beam information indication method according to an embodiment of this application is described in detail below through some embodiments and application scenarios thereof with reference to the accompanying drawings.

It should be noted that the premise of implementing the following embodiments of this application is that the network side device configures a unified TCI state for the terminal, or configures a TCI state pool with a unified TCI state for the terminal. Optionally, the network side device may alternatively configure a TCI mode (joint TCI or separate TCI).

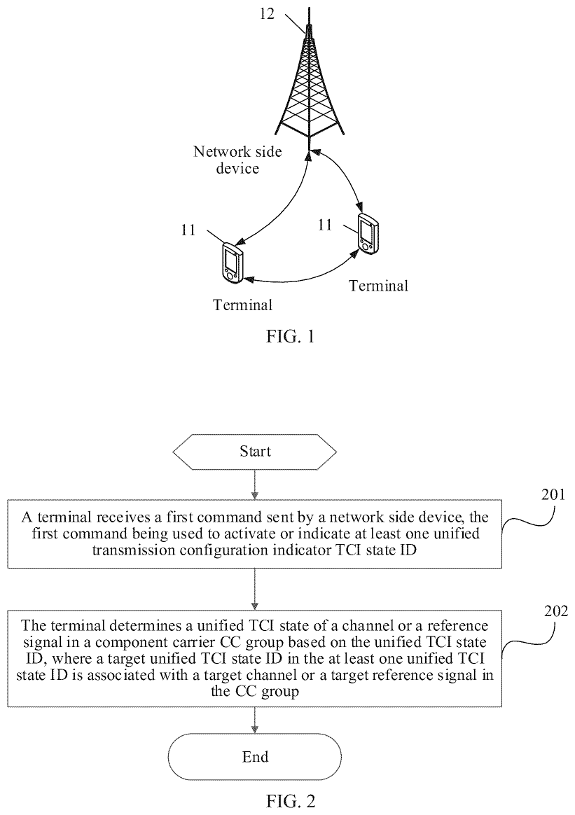

As shown in FIG. 2, an embodiment of this application provides a beam information indication method, which is applied to a terminal and includes the following steps:

Step 201: A terminal receives a first command sent by a network side device. The first command is used to activate or indicate at least one unified transmission configuration indicator TCI state ID.

Step 202: The terminal determines a unified TCI state of a channel or a reference signal in a component carrier CC group based on the unified TCI state ID.

A target unified TCI state ID in the at least one unified TCI state ID is associated with a target channel or a target reference signal in the CC group.

In this embodiment, in a case that the network side device configures a unified TCI state for the terminal, if a CC group (that is, a CA scenario) is also configured, the network side device sends a first command to the terminal to indicate or activate one or more unified TCI state IDs. Based on the unified TCI state ID indicated by the network side device, the terminal can determine a channel or a signal that applies a TCI state corresponding to the unified TCI state ID, thereby determining beam information of the channel or the signal.

The at least one unified TCI state ID is associated with a channel or a reference signal on a CC/BWP in a configured CC group, and the association relationship may be direct association or indirect association through some information. Through the association relationship, the terminal can determine a channel or reference signal in which a unified TCI state activated/indicated by the first command. Optionally, the CC group may be CC lists, and a quantity of the CC lists may be N. N is a positive integer.

The target channel or the target reference signal may mean a part of channels or reference signals in the CC group, for example: a UE-dedicated PDCCH, a UE-dedicated PDSCH, a UE-dedicated PUCCH, a PUSCH, a non-UE-dedicated PDCCH and an associated PDSCH thereof, a CSI-RS, an SRS that can share a unified TCI state. The target channel or the target reference signal may alternatively mean all channels or reference signals in the CC group.

Optionally, the first command may be a MAC CE, which is used to activate a unified TCI state corresponding to one or more TCI codepoints, or a DCI, which is used to indicate a unified TCI state.

Optionally, the first command is used to activate or indicate at least two unified TCI state IDs. When the first command activates or indicates one unified TCI state ID, a TCI state corresponding to the unified TCI state ID is applied to a target channel/target reference signal associated with the unified TCI state ID, that is, used to determine a unified TCI state of the target channel/target reference signal associated with the unified TCI state ID. The target unified TCI state generally means any one of the at least one unified TCI state ID. Taking an example in which the first command indicates or activates two unified TCI state IDs (TCI state ID1 and TCI state ID2), the TCI state ID1 is associated with a first part of channels/reference signals in the CC group, and the TCI state ID2 is associated with a second part of channels/reference signals in the CC group. Therefore, a TCI state 1 corresponding to the TCI state ID1 is a unified TCI state of the first part of channels/reference signals, and TCI state2 corresponding to the TCI state ID2 is a unified TCI state of the second part of channels/reference signals.

In the embodiment of this application, the network side device indicates or activates at least one unified TCI state ID through a first command. The unified TCI state ID is associated with a channel or a reference signal in a CC group. Based on the unified TCI state ID, the terminal can determine a TCI state of a group of channels or reference signals associated with the unified TCI state ID. This can be applied to beam information indication in a multi-TRP scenario, and simplify signaling overheads of unified TCI state update in a CA scenario.

As an optional embodiment, the method further includes the following: The terminal receives a second command sent by the network side device. The second command is used to configure at least one TCI state pool for the terminal. The TCI state pool includes a unified TCI state corresponding to the unified TCI state ID. Each CC or each BWP in the CC group has a corresponding TCI state pool.

In this embodiment, the network side device configures at least one TCI state pool for the terminal, and each TCI state pool may include one or more TCI states. When the TCI state pools are configured, each CC/BWP has a corresponding TCI state pool, and TCI state pools corresponding to different CCs/BWPs may be the same or different. For example, TCI state pool 1 is configured in PDSCH-config of BWP1, and TCI state pool 2 is configured in PDSCH-config of BWP2. Each pool includes at least one TCI state.

That each CC or each BWP in the CC group has a corresponding TCI state pool may be understood as follows: Configuration information of the CC or the BWP includes configuration information of the TCI state pool, or configuration information of the CC or the BWP includes indication information of a reference CC or a reference BWP, and the TCI state pool is configured in configuration information of the reference CC or the reference BWP. For example, if configuration information of a second CC in the CC group includes no related configuration information of the TCI state pool, the configuration information of the second CC may indicate information of the reference CC, and the configuration information of the indicated reference CC includes the configuration information of the TCI state pool.

The first command indicates/activates at least one unified TCI state ID, and the terminal can determine a TCI state corresponding to the unified TCI state ID from the TCI state pool based on the unified TCI state ID, and therefore takes the TCI state as a unified TCI state of a channel/reference signal associated with the unified TCI state ID. It should be noted that in different TCI state pools, TCI states corresponding to a same unified TCI state ID may be different. For example, TCI state ID1 corresponds to TCI state1 in pool1, and TCI state ID1 also corresponds to TCI state2 in pool2.

Optionally, if configuration information of a first CC or a first BWP in the CC group includes first information, the first information is in a one-to-one correspondence with a TCI state pool corresponding to the first CC or the first BWP.

That configuration information of a first CC or a first BWP in the CC group includes first information may be as follows: The configuration information of the first CC or the first BWP includes both the first information and configuration information of a channel or a reference signal, and the configuration information of the first CC or the first BWP further includes a corresponding relationship between the first information and the channel or the reference signal. Alternatively, the configuration information of the first CC or the first BWP includes configuration information of a channel or a reference signal, and the configuration information of the channel or the reference signal includes the first information. Alternatively, the configuration information of the first CC or the first BWP includes first information, and the first information may include configuration information of a channel or a reference signal of the first CC or the first BWP.

The first information may be used to indicate a TRP. For example, the value of the first information is 1, which corresponds to TRP1; or the value of the first information is 2, which corresponds to TRP2 (as an example only). Each CC/BWP may be configured with a plurality of pieces of first information corresponding to different channels or reference signals in the CC/BWP respectively. Therefore, beam information of a channel or a reference signal of each CC/BWP is determined in a multi-TRP scenario based on the indicated or activated TCI state ID.

In this embodiment, the first CC may generally mean any CC with configuration information including first information in the CC group, and the first BWP may generally mean any BWP with configuration information including first information in the CC group. For the CC/BWP including the first information, a corresponding TCI state pool corresponds to the configured first information. For example, if first information configured on CC1 is A and B and TCI state pools configured on the CC1 are pool1 and pool2, for the CC1, the first information A corresponds to the pool1 and the first information B corresponds to the pool2. After the terminal receives a first command, if a channel associated with a unified TCI state ID indicated/activated by the first command is a channel corresponding to the first information A, a TCI state corresponding to the unified TCI state ID is determined by pool1 corresponding to the first information A on the CC1.

Optionally, the configuration information of the TCI state pool is included in one of the following information:
configuration information of any CC in the CC group;
configuration information of any bandwidth part BWP in the CC group;
configuration information of a reference CC in the CC group; and
configuration information of a reference BWP in the CC group.

Optionally, if the configuration information of the TCI state pool is included in the configuration information of the reference CC in the CC group, configuration information of a second CC in the CC group includes indication information of the reference CC, and the configuration information of the second CC includes no configuration information of the TCI state pool, or
if the configuration information of the TCI state pool is included in the configuration information of the reference BWP in the CC group, configuration information of a second BWP in the CC group includes indication information of the reference BWP, and the configuration information of the second BWP includes no configuration information of the TCI state pool.

In this embodiment, the TCI state pool may be configured on any CC/BWP or on a reference CC/BWP. For a CC/BWP without a TCI state pool (that is, the second CC/second BWP), configuration information thereof (for example, PDSCH-config or BWP config) may indicate information on a reference CC/BWP at which the TCI state pool is located, that is, indicate that the CC/BWP without a TCI state pool uses the TCI state pool configured on the reference CC/BWP.

Optionally, the network side device may further configure a TCI mode for each CC in the CC group, such as a joint TCI or a separate TCI. If the TCI mode of the CC1 is configured as the joint TCI, the network side device configures a joint TCI state pool for the CC1. If the TCI mode of the CC1 is configured as the separate TCI, the network side device configures a DL TCI state pool and a UL TCI state pool for the CC1. Optionally, TCI modes of all CC/BWPs in the CC group may be alternatively configured to be the same.

Optionally, the reference CC is one of the following CCs.

1) Any CC in the CC group.

2) A CC configured with all first information in the CC group. The first information may have a plurality of values, and if a CC in the CC group is configured with all first information values, the CC may be used as the reference CC. Taking an example in which the first information is CORESETPoolIndex, if there are at most two CORESETPoolIndex values, a CC configured with two CORESETPoolIndex values is used as the reference CC. Different CORESETPoolIndex values may correspond to different TRPs.

3) A CC with first information configured as a target value in the CC group.

The target value of the first information may be set as required. The target value may be one value or a plurality of values. Assuming that the first information has a plurality of values, a CC configured with one or a plurality of first information values may be used as a reference CC. Taking an example in which the first information is CORESETPoolIndex, for example, a CC configured with only CORESETPoolIndex 0 is used as a reference CC for other CCs configured with only CORESETPoolIndex 0 or CCs including CORESETPoolIndex 0 configured (that is, the CCs may be also configured with other CORESETPoolIndex values), or a CC configured with only CORESETPoolIndex 1 is used as a reference CC for other CCs configured with only CORESETPoolIndex 1 or including CORESETPoolIndex 1 configured.

In this embodiment, if a CC configured with only the target value of the first information is used as a reference CC/BWP for other CCs configured with the target value, and the network side device configures respective TCI state pools for different first information values, the TCI state pool configured on this reference CC may be used as a pool corresponding to the target value on other CCs containing the target value.

Optionally, the reference BWP is one of the following BWPs:
any BWP in the CC group;
a BWP configured with all first information in the CC group; and
a BWP with first information configured as a target value in the CC group.

The method for configuring the reference BWP is the same as the method for configuring the above-mentioned reference CC, and details are not described herein.

Optionally, that a target unified TCI state ID in the at least one unified TCI state ID is associated with a target channel or a target reference signal in the CC group includes the following:
(1) the target unified TCI state ID has a corresponding relationship with the target channel or the target reference signal. That is, each unified TCI state ID in the at least one unified TCI state ID is directly associated with a corresponding channel/reference signal. In other words, each unified TCI state ID has its own application object, and is applied to some channels/reference signals. For example, if the unified TCI state ID is TCI state ID 1 and a corresponding (applied) channel is a channel 1, the TCI state ID 1 is used to indicate a unified TCI state of the channel 1. If the unified TCI state ID is TCI state ID 2 and a corresponding (applied) channel is a channel 2, the TCI state ID 2 is used to indicate a unified TCI state of the channel 2;
or,
(2) the target unified TCI state ID has a corresponding relationship with first information, and the first information has a corresponding relationship with the target channel or the target reference signal. That is, each unified TCI state ID in the at least one unified TCI state ID is directly associated with a corresponding channel/reference signal through the first information, and the target unified TCI ID is the same as the first information corresponding to the target channel. That is, each unified TCI state ID has an application object, and is applied to channels/reference signals with the same first information corresponding to the unified TCI state ID. Taking an example in which the first information is CORESETPoolIndex, for example, if the unified TCI state ID is TCI state ID 1, corresponding first information is CORESETPoolIndex 1 and a channel corresponding to CORESETPoolIndex 1 is a channel 1, the TCI state ID 1 is used to indicate a unified TCI state of the channel 1, that is, to indicate a unified TCI state of the channel corresponding to CORESETPoolIndex 1.

Since the target unified TCI state ID is directly associated with the target channel or the target reference signal or associated therewith through first information, when a TCI state of a channel or a reference signal is determined based on the unified TCI state ID, a channel or a reference signal to which the unified TCI state ID indicated/activated by the first command is applied can be determined based on the direct or indirect association relationship.

As different values of the first information can be used to indicate different TRPs, the embodiment of this application can indicate a TCI state of a channel or a reference signal in a multi-TRP scenario and a CA scenario, that is, indicate beam information.

Optionally, the first information includes at least one of the following:
a control resource set CORESET ID;
a CORESET pool index;
a CORESET group ID;
an ID of interrelated search spaces (SSs);
an ID of a CORESET at which interrelated SSs are located;
transmission opportunity information on interrelated SSs;
transmission time information on interrelated SSs;
a transmission-reception point TRP ID;
a channel group ID;
a physical uplink control channel PUCCH resource group ID;
a physical cell identifier (PCI); or
a terminal panel ID.

Optionally, the first information is configured in one of the following information:
configuration information (for example, CC config and cell config) of a CC in the CC group;
configuration information (for example, BWP config) of a BWP in the CC group; and
configuration information (for example, cell group config) of a cell group in which the CC group is located.

Optionally, a method for configuring the first information includes one of the following.

(1) All CCs or all BWPs in the same CC group are configured with the same first information.

In this embodiment, if the network side device is configured with the first information, it can be understood as a case of multi-DCI or single DCI scheduling. All CCs/all BWPs in the CC group may be configured with the same first information, and the same first information may be one value or the same multiple values. Taking an example in which the first information configured in a case of multi-DCI scheduling is CORESETPoolIndex, all CCs/all BWPs in the CC group each may be configured with only CORESETPoolIndex 0 or only CORESETPoolIndex 1, or all CCs/all BWPs in the CC group each may be configured with CORESETPoolIndex 0 and CORESETPoolIndex 1. The first information may be configured in each CC/BWP of the CC group, or in a cell group to which the CC group belongs. Assuming that the first information is configured in each CC/BWP, a first information value configured in each CC/BWP is the same, or assuming that the first information is configured in the cell group, the first information can be applied to all CCs/BWPs of a CC list.

(2) In the CC group, a first part of CCs or a first part of BWPs each are configured with one piece of first information, and a second part of CCs or a second part of BWPs each are configured with at least two pieces of first information.

In the CC group, a part of CCs/BWPs each may be alternatively configured with only one first information value, and another part of CCs/BWPs each may be configured with a plurality of first information values. In CCs/BWPs each configured with one first information value, the first information values on different CCs may be different or the same. For CCs/BWPs each configured with a plurality of first information values, since the values of the first information can correspond to different TRPs, the CCs/BWPs can be used for signal transceiving of a plurality of corresponding TRPs. For example, CORESETPoolIndex 1 and CORESETPoolIndex 2 are configured on a plurality of CCs, and CORESETPoolIndex 1 corresponds to unified TCI state ID 1 and corresponds to a channel 1; and CORESETPoolIndex 2 corresponds to unified TCI state ID 2, and corresponds to a channel 2. Then the TCI state ID 1 is used to determine a unified TCI state of the channel 1 corresponding to CORESETPoolIndex 1 on the plurality of CCs, and the channel 1 can be transmitted by a signal of TRP1; The TCI state ID 2 is used to determine a unified TCI state of the channel 2 corresponding to CORESETPoolIndex 2 on the plurality of CCs, and the channel 2 can be transmitted by a signal of TRP2.

(3) In the CC group, a first part of CCs or a first part of BWPs and a second part of CCs or a second part of BWPs each are configured with one piece of first information, and the first information that the first part of CCs or the first part of BWPs are configured with is different from the first information that the second part of CCs or the second part of BWPs are configured with.

In this embodiment, in the CC group, a part of CCs/BWPs each may be configured with only one first information value, and another part of CCs/BWPs each may be also configured with only one first information value, but the configured first information values of the two parts of CCs/BWPs are different.

Taking an example in which the first information configured in a case of multi-DCI scheduling is CORESETPoolIndex, in the CC group, a first part of CCs/BWPs each are configured with only CORESETPoolIndex 0, and a second part of CCs/BWPs each are configured with only CORESETPoolIndex 1.

(4) In the CC group, a first part of CCs or a first part of BWPs and a second part of CCs or a second part of BWPs each are configured with at least two pieces of first information, and the first information that the first part of CCs or the first part of BWPs are configured with is at least partially different from the first information that the second part of CCs or the second part of BWPs are configured with.

In this embodiment, in the CC group, a part of CCs/BWPs each may be alternatively configured with a plurality of first information values, and another part of CCs/BWPs each may be also configured with a plurality of first information values, but the configured first information values of the two parts of CCs/BWPs are not completely the same.

Taking an example in which the first information configured in a case of multi-DCI scheduling is CORESETPoolIndex, in the CC group, a first part of CCs/BWPs each are configured with CORESETPoolIndex 0, CORESETPoolIndex 1 and CORESETPoolIndex 2. A second part of CCs/BWPs each are configured with CORESETPoolIndex 1, CORESETPoolIndex 3 and CORESETPoolIndex 4.

Determining of a unified TCI state of a channel or a reference signal by the terminal may or may not be based on the first information.

Optionally, the terminal determines a unified TCI state of a channel or a reference signal in a CC group based on the unified TCI state ID by the following the two methods.

Method 1: A unified TCI state of a target channel or a target reference signal corresponding to the target TCI state ID is determined based on the target TCI state ID and a target TCI state pool in the at least one TCI state pool.

In this embodiment, when determining the unified TCI state of the channel or the reference signal based on the at least one unified TCI state ID, the terminal can select, based on a corresponding relationship between the unified TCI state ID and the channel/reference signal, a TCI state corresponding to the target TCI state ID from the target TCI state pool as a unified TCI state of the target channel/target reference signal corresponding to the target TCI state ID. For example, if the target unified TCI state ID is TCI state ID1, and a corresponding target channel is a channel 1 (channels 1 may be configured on a plurality of CCs), a TCI state corresponding to the TCI state ID1 can be selected from the target TCI state pool as a unified TCI state of a plurality of channels 1 on the plurality of CCs.

Method II: A unified TCI state of a target channel or a target reference signal corresponding to first information corresponding to the target TCI state ID is determined based on the target TCI state ID and a target TCI state pool in the at least one TCI state pool.

In this embodiment, when determining the unified TCI state of the channel or the reference signal based on the at least one unified TCI state ID, if the first information is configured, the terminal can select, based on a corresponding relationship between the unified TCI state ID, the first information and the channel/reference signal, a TCI state corresponding to the target TCI state ID from the target TCI state pool as a unified TCI state of the target channel/target reference signal corresponding to the first information corresponding to the target TCI state ID.

For example, if the target unified TCI state ID is TCI state ID1, corresponding first information is CORESETPoolIndex 1 and a target channel corresponding to CORESETPoolIndex1 is a channel 1 (channels 1 may be configured on a plurality of CCs), a TCI state corresponding to the TCI state ID1 can be selected from the target TCI state pool as a unified TCI state of a plurality of channels 1 corresponding to CORESETPoolIndex1 and on the plurality of CCs.

Optionally, the method further includes:
determining the target TCI state pool based on a target CC or a target BWP at which the target channel or the target reference signal is located,
or,
determining the target TCI state pool based on a target CC or a target BWP at which the target channel or the target reference signal is located, and the first information corresponding to the target channel or the target reference signal.

In this embodiment, when the terminal determines a TCI state of a channel or a reference signal based on an indicated or activated unified TCI state ID, a TCI state pool from which a unified TCI state is selected for the channel or the reference signal based on the unified TCI state ID needs to be determined. Since each CC or each BWP in the CC group has a corresponding TCI state pool, the TCI states corresponding to the same unified TCI state ID in different TCI state pools may be different. Therefore, the terminal needs to determine a target TCI state pool.

When the target TCI state pool is determined, a TCI state pool configured on a CC or BWP at which the target channel/target reference signal corresponding to the target TCI state ID is located may be used as the target TCI state pool, or the target TCI state pool can be determined based on configured first information, and a TCI state pool corresponding to the first information in the CC or BWP at which the target channel/target reference signal corresponding to the target TCI state ID is located may be used as the target TCI state pool. A TCI state corresponding to the target unified TCI state ID in the target TCI state pool is used as a unified TCI state of the target channel or the target reference signal.

If the network side device is configured with the first information, when the network side device activates or indicates a unified TCI state ID corresponding to a target value of the first information, a TCI state corresponding to the unified TCI state ID is determined as a unified TCI state of a channel/reference signal corresponding to the target value. Optionally, in this case, the first command may be indication signaling corresponding to the target value. Taking an example in which a target value of the first information is CORESETPoolIndex x, since each TRP has its own beam indication signaling, assuming that CORESETPoolIndex x corresponds to TRP1, a unified TCI state ID x corresponding to the CORESETPoolIndex x is activated or indicated by indication signaling of the TRP1. Then the unified TCI state ID x is used to update TCI states of channels or reference signals corresponding to CORESETPoolIndex x on all CCs/BWPs in the CC group, that is, to determine common QCL information of a downlink target signal and/or a common UL TX spatial filter of an uplink target signal corresponding to CORESETPoolIndex x on all CCs/BWPs in the CC group.

For example, if a TCI mode configured by the network side device is a joint TCI, the joint TCI is used to determine the common QCL information of the downlink target signal and the common UL TX spatial filter of the uplink target signal.

If a TCI mode configured by the network side device is a separate TCI, a DL TCI state ID in the unified TCI state ID x is used to determine the common QCL information of the downlink target signal, and a UL TCI state ID is used to determine the common UL TX spatial filter of the uplink target signal.

In this embodiment, when the unified TCI framework is applied in a multi-TRP scenario, a unified TCI state of channels on a group of carriers is determined based on the unified TCI state ID indicated or activated by the network side device, which can simplify signaling overheads of TCI state update in a CA scenario.

Optionally, that the terminal determines a unified TCI state of a channel or a reference signal in a CC group based on the unified TCI state ID includes the following:
the terminal determines a unified TCI state of all channels or reference signals in the CC group based on the at least one unified TCI state ID. In this case, target signals or target reference signals associated with a target unified TCI state ID are all channels or reference signals in the CC group, that is, the unified TCI state of all the channels or reference signals is determined by the target unified TCI state ID. For example, all or part of unified TCI states of all the channels or reference signals in the CC group can be determined. For example, during repeated transmission or multi-beam transmission, unified TCI states determined by the target unified TCI ID can only be used as part of TCI states of such channels or reference signals. Above-mentioned all the channels or reference signals mean all channels or reference signals that always use or are configured to share unified TCI states in the CC group;
or,
the terminal determines a unified TCI state of a target channel or a target reference signal corresponding to the target unified TCI state ID in the CC group based on a target unified TCI ID in the at least one unified TCI state ID. In this case, target signals or target reference signals associated with the target unified TCI state ID may be part of channels or reference signals in the CC group, that is, the unified TCI state of part of the channels or reference signals is determined by the target unified TCI state ID. For example, all or part of unified TCI states of target channels or target reference signals in the CC group can be determined. The above-mentioned part of the channels or reference signals mean channels or reference signals that always use or are configured to share unified TCI states in the CC group and are associated with the target unified TCI state ID.

In this embodiment, when a quantity of the at least one unified TCI state ID is one, it can be understood that all CCs/BWPs are single TRPs, or when there are a plurality of indicated TCI state IDs, it can be understood that all CCs/BWPs are multi-TRPs or at least one CC/BWP is a multi-TRP. Target signals or channels on all CCs/BWPs use indicated TCI states, or all or part of the indicated TCI states are used for each target signal or channel on each CC/BWP.

Optionally, in a case that the first information is configured, a unified TCI state ID activated or indicated by the first command corresponds to the first information. As there may be one or more indicated or activated unified TCI state IDs, there is one or more values of corresponding first information. The indicated unified TCI state ID is used to update TCI states of target signals corresponding to the first information on all CCs/BWPs in the CC group, that is, to determine common QCL information of a downlink target signal and/or a common UL TX spatial filter of an uplink target signal.

Optionally, the unified TCI state ID includes one of the following:
K joint TCI state IDs;
K pairs of separate TCI state IDs; and
K1 joint TCI state IDs and K2 pairs of separate TCI state IDs,
where K, K1 and K2 are all positive integers.

In this embodiment, the network side device can activate or indicate K joint TCI state IDs or K pairs of separate TCI state IDs or K1 joint TCI state IDs+K2 pairs of separate TCI state IDs. Correspondingly, it is understood as K TRPs or K1+K2 TRPs.

Each pair of separate TCI state IDs may be any of one DL TCI state ID and one UL TCI state ID, one DL TCI state ID, and one UL TCI state ID.

Optionally, at least one unified TCI state ID indicated by the first command each may correspond to one codepoint, or each TCI state ID in the indicated TCI state ID corresponds to one codepoint. Optionally, when the network side device activates a TCI state by a MAC CE, at least one codepoint corresponds to a plurality of joint TCI state IDs, or a plurality of pairs of separate TCI state IDs, or at least one joint TCI state ID and at least one pair of separate TCI state IDs.

Optionally, the method further includes:
determining an effective time of the unified TCI state based on a CC or BWP with a minimum SCS in sub-carrier spacings (SCSs) of all BWPs of CCs applying the unified TCI state in the CC group,
or
determining an effective time of the unified TCI state based on a CC or BWP with a minimum SCS in SCSs of active BWPs of CCs applying the unified TCI state in the CC group.

In this embodiment, the effective time of the unified TCI state indicated by the network side device can be determined based on the CC/BWP with a minimum SCS in the CCs/BWPs applying the indicated TCI state. The BWPs may be all configured BWPs or all active BWPs in all CCs.

In the embodiment of this application, the network side device indicates at least one unified TCI state ID through the first command, and determines a TCI state of a corresponding channel or reference signal based on the at least one unified TCI state ID. A CC/BWP applying the TCI state may be a CC/BWP configured with a first information value, all CCs/BWPs, or the like. When the TCI state is applied to BWPs, the BWPs may be all BWPs of all CCs, or active BWPs of all CCs, or all BWPs of CCs configured with a first information value, or active BWPs of CCs configured with a first information value, or all BWPs configured with a first information value, or active BWPs configured with a first information value.

In the embodiment of this application, the network side device indicates or activates at least one unified TCI state ID through a first command. The unified TCI state ID is associated with a channel or a reference signal in a CC group. Based on the unified TCI state ID, the terminal can determine a TCI state of a group of channels or reference signals associated with the unified TCI state ID. This can be applied to beam information indication in a multi-TRP scenario, and simplify signaling overheads of unified TCI state update in a CA scenario.

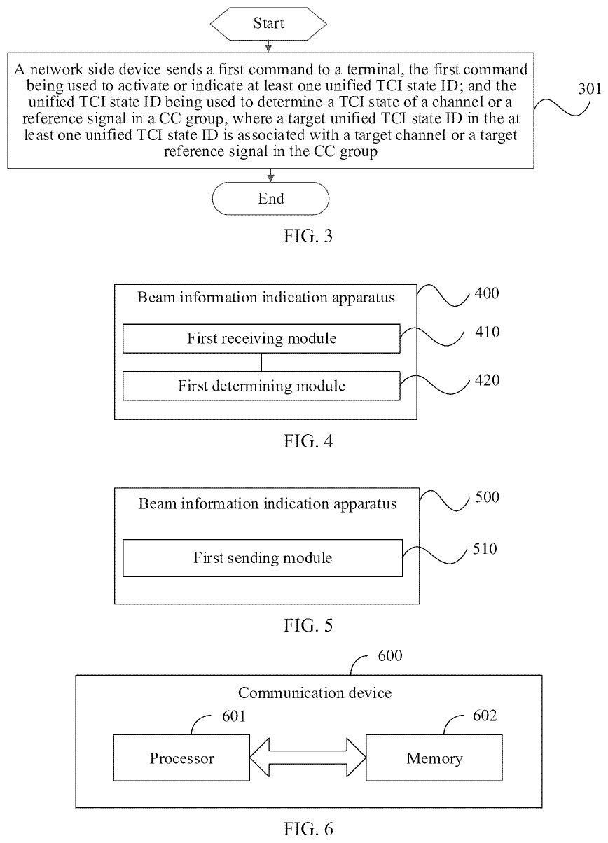

As shown in FIG. 3, an embodiment of this application further provides a beam information indication method, which is applied to a network side device and includes the following steps:

Step 301: A network side device sends a first command to a terminal. The first command is used to activate or indicate at least one unified TCI state ID. The unified TCI state ID is used to determine a TCI state of a channel or a reference signal in a CC group. A target unified TCI state ID in the at least one unified TCI state ID is associated with a target channel or a target reference signal in the CC group. Therefore, the terminal determines a unified TCI state of a channel or a reference signal in a CC group based on the unified TCI state ID.

In this embodiment, in a case that the network side device configures a unified TCI state for the terminal, if a CC group is also configured, the network side device sends a first command to the terminal to indicate or activate one or more unified TCI state IDs. Based on the unified TCI state ID indicated by the network side device, the terminal can determine a channel or a signal that applies a TCI state corresponding to the unified TCI state ID, thereby determining beam information of the channel or the signal.

The at least one unified TCI state ID is associated with a channel or a reference signal on a CC/BWP in a configured CC group, and the association relationship may be direct association or indirect association through some information. Through the association relationship, the terminal can determine a channel or reference signal in which a unified TCI state activated/indicated by the first command. The CC group may be CC lists, and a quantity of the CC lists may be N. N is a positive integer.

Optionally, the first command is used to activate or indicate at least two unified TCI state IDs. When the first command indicates one unified TCI state ID, a TCI state corresponding to the unified TCI state ID is applied to a target channel/target reference signal associated with the unified TCI state ID, that is, used to determine a unified TCI state of the target channel/target reference signal associated with the unified TCI state ID. The target unified TCI state generally means any one of the at least one unified TCI state ID.

Optionally, the first command may be a MAC CE, which is used to activate a unified TCI state corresponding to one or more TCI codepoints, or a DCI, which is used to indicate a unified TCI state.

In the embodiment of this application, the network side device indicates or activates at least one unified TCI state ID through a first command. The unified TCI state ID is associated with a channel or a reference signal in a CC group. Based on the unified TCI state ID, the terminal can determine a TCI state of a group of channels or reference signals associated with the unified TCI state ID. This can be applied to beam information indication in a multi-TRP scenario, and simplify signaling overheads of unified TCI state update in a CA scenario.

Optionally, the method further includes: The network side device sends a second command to the terminal. The second command is used to configure at least one TCI state pool for the terminal. The TCI state pool includes a unified TCI state corresponding to the unified TCI state ID. Each CC or each BWP in the CC group has a corresponding TCI state pool.

In this embodiment, the network side device configures at least one TCI state pool for the terminal, and each TCI state pool may include one or more TCI states. When the TCI state pools are configured, each CC/BWP has a corresponding TCI state pool, and TCI state pools on different CCs/BWPs may be the same or different.

The first command indicates/activates at least one unified TCI state ID, and the terminal can determine a TCI state corresponding to the unified TCI state ID from the TCI state pool based on the unified TCI state ID, and therefore takes the TCI state as a unified TCI state of a channel/reference signal associated with the unified TCI state ID.

It should be noted that in different TCI state pools, TCI states corresponding to a same unified TCI state ID may be different. For example, TCI state ID1 corresponds to TCI state1 in pool1, and TCI state ID1 also corresponds to TCI state2 in pool2.

That each CC or each BWP in the CC group has a corresponding TCI state pool may be understood as follows: Configuration information of the CC or the BWP includes configuration information of the TCI state pool, or configuration information of the CC or the BWP includes indication information of a reference CC or a reference BWP, and the TCI state pool is configured in configuration information of the reference CC or the reference BWP.

Optionally, if configuration information of a first CC or a first BWP in the CC group includes first information, the first information is in a one-to-one correspondence with a TCI state pool corresponding to the first CC or the first BWP.

That configuration information of a first CC or a first BWP in the CC group includes first information may be as follows: The configuration information of the first CC or the first BWP includes both the first information and configuration information of a channel or a reference signal, and the configuration information of the first CC or the first BWP further includes a corresponding relationship between the first information and the channel or the reference signal. Alternatively, the configuration information of the first CC or the first BWP includes configuration information of a channel or a reference signal, and the configuration information of the channel or the reference signal includes the first information. Alternatively, the configuration information of the first CC or the first BWP includes first information, and the first information may include configuration information of a channel or a reference signal of the first CC or the first BWP.

The first information may be used to indicate a TRP. Therefore, beam information of a channel or a reference signal of each CC/BWP is determined in a multi-TRP scenario based on the indicated or activated TCI state ID. The first CC may generally mean any CC configured with first information in the CC group, and the first BWP may generally mean any BWP configured with first information in the CC group. For the CC/BWP configured with the first information, a corresponding TCI state pool corresponds to the configured first information.

Optionally, configuration information of the TCI state pool is configured in one of the following information:
configuration information of any CC in the CC group;
configuration information of any BWP in the CC group;
configuration information of a reference CC in the CC group; and
configuration information of a reference BWP in the CC group.

Optionally, if the configuration information of the TCI state pool is included in the configuration information of the reference CC in the CC group, configuration information of a second CC in the CC group includes indication information of the reference CC, and the configuration information of the second CC includes no configuration information of the TCI state pool, or
if the configuration information of the TCI state pool is included in the configuration information of the reference BWP in the CC group, configuration information of a second BWP in the CC group includes indication information of the reference BWP, and the configuration information of the second BWP includes no configuration information of the TCI state pool.

In this embodiment, the TCI state pool may be configured on any CC/BWP or on a reference CC/BWP. For a CC/BWP without a TCI state pool (that is, the second CC/second BWP), configuration information thereof (for example, PDSCH-config or BWP config) may indicate information on a reference CC/BWP at which the TCI state pool is located, that is, indicate that the CC/BWP without a TCI state pool uses the TCI state pool configured on the reference CC/BWP.

Optionally, the network side device may further configure a TCI mode for each CC in the CC group, such as a joint TCI or a separate TCI. If the TCI mode of the CC is configured as the joint TCI, the network side device configures a joint TCI state pool for the CC. If the TCI mode of the CC is configured as the separate TCI, the network side device configures a DL TCI state pool and a UL TCI state pool for the CC.

Optionally, the reference CC is one of the following CCs.

Any CC in the CC group.

A CC configured with all first information in the CC group. The first information may have a plurality of values, and if a CC in the CC group is configured with all first information values, the CC may be used as the reference CC. Taking an example in which the first information is CORESETPoolIndex, if there are at most two CORESETPoolIndex values, a CC configured with two CORESETPoolIndex values is used as the reference CC.

A CC with first information configured as a target value in the CC group. The target value of the first information may be set as required. The target value may be one value or a plurality of values. Assuming that the first information has a plurality of values, a CC configured with one or a plurality of first information values may be used as a reference CC.

In this embodiment, if a CC configured with only the target value of the first information is used as a reference CC/BWP for other CCs configured with the target value, and the network side device configures respective TCI state pools for different first information values, the TCI state pool configured on this reference CC may be used as a pool corresponding to the target value on other CCs containing the target value.

Optionally, the reference BWP is one of the following BWPs:
any BWP in the CC group;
a BWP configured with all first information in the CC group; and
a BWP with first information configured as a target value in the CC group.

The method for configuring the reference BWP is the same as the method for configuring the above-mentioned reference CC, and details are not described herein.

Optionally, that a target unified TCI state ID in the at least one unified TCI state ID is associated with a target channel or a target reference signal in the CC group includes the following:
the target unified TCI state ID has a corresponding relationship with the target channel or the target reference signal. That is, each unified TCI state ID in the at least one unified TCI state ID is directly associated with a corresponding channel/reference signal. In other words, each unified TCI state ID has its own application object, and is applied to some channels/reference signals;
or,
the target unified TCI state ID has a corresponding relationship with first information, and the first information has a corresponding relationship with the target channel or the target reference signal. That is, each unified TCI state ID in the at least one unified TCI state ID is directly associated with a corresponding channel/reference signal through the first information, and the target unified TCI ID is the same as the first information corresponding to the target channel. That is, each unified TCI state ID has an application object, and is applied to channels/reference signals with the same first information corresponding to the unified TCI state ID.

Since the target unified TCI state ID is directly associated with the target channel or the target reference signal or associated therewith through first information, when a TCI state of a channel or a reference signal is determined based on the unified TCI state ID, a channel or a reference signal to which the unified TCI state ID indicated/activated by the first command is applied can be determined based on the direct or indirect association relationship.

As different values of the first information can be used to indicate different TRPs, the embodiment of this application can indicate a TCI state of a channel or a reference signal in a multi-TRP scenario and a CA scenario, that is, indicate beam information.

Optionally, the first information includes at least one of the following:
a CORESET ID;
a CORESET pool index;
a CORESET group ID;
an ID of interrelated search spaces SSs;
an ID of a CORESET at which interrelated SSs are located;
transmission opportunity information on interrelated SSs;
transmission time information on interrelated SSs;
a TRP ID;
a channel group ID;
a PUCCH resource group ID;
a physical cell identifier PCI; or
a terminal panel ID.

Optionally, the first information is configured in one of the following information:
configuration information of a CC in the CC group;
configuration information of a BWP in the CC group; and
configuration information of a cell group in which the CC group is located.

Optionally, a method for configuring the first information includes one of the following:

(1) All CCs or all BWPs in the same CC group are configured with the same first information.

In this embodiment, if the network side device is configured with the first information, it can be understood as a case of multi-DCI or single DCI scheduling. All CCs/all BWPs in the CC group may be configured with the same first information, and the same first information may be one value or the same multiple values. Taking an example in which the first information configured in a case of multi-DCI scheduling is CORESETPoolIndex, all CCs/all BWPs in the CC group each may be configured with only CORESETPoolIndex 0 or only CORESETPoolIndex 1, or all CCs/all BWPs in the CC group each may be configured with CORESETPoolIndex 0 and CORESETPoolIndex 1.

The first information may be configured in each CC/BWP of the CC group, or in a cell group to which the CC group belongs. Assuming that the first information is configured in each CC/BWP, a first information value configured in each CC/BWP is the same, or assuming that the first information is configured in the cell group, the first information can be applied to all CCs/BWPs of a CC list.

(2) In the CC group, a first part of CCs or a first part of BWPs each are configured with one piece of first information, and a second part of CCs or a second part of BWPs each are configured with at least two pieces of first information.

In the CC group, a part of CCs/BWPs each may be alternatively configured with only one first information value, and another part of CCs/BWPs each may be configured with a plurality of first information values. In CCs/BWPs each configured with one first information value, the first information values on different CCs may be different or the same. For CCs/BWPs each configured with a plurality of first information values, since the values of the first information can correspond to different TRPs, the CCs/BWPs can be used for signal transceiving of a plurality of corresponding TRPs.

(3) In the CC group, a first part of CCs or a first part of BWPs and a second part of CCs or a second part of BWPs each are configured with one piece of first information, and the first information that the first part of CCs or the first part of BWPs are configured with is different from the first information that the second part of CCs or the second part of BWPs are configured with.

In this embodiment, in the CC group, a part of CCs/BWPs each may be configured with only one first information value, and another part of CCs/BWPs each may be also configured with only one first information value, but the configured first information values of the two parts of CCs/BWPs are different.

Taking an example in which the first information configured in a case of multi-DCI scheduling is CORESETPoolIndex, in the CC group, a first part of CCs/BWPs each are configured with only CORESETPoolIndex 0, and a second part of CCs/BWPs each are configured with only CORESETPoolIndex 1.

(4) In the CC group, a first part of CCs or a first part of BWPs and a second part of CCs or a second part of BWPs each are configured with at least two pieces of first information, and the first information that the first part of CCs or the first part of BWPs are configured with is at least partially different from the first information that the second part of CCs or the second part of BWPs are configured with.

In this embodiment, in the CC group, a part of CCs/BWPs each may be alternatively configured with a plurality of first information values, and another part of CCs/BWPs each may be also configured with a plurality of first information values, but the configured first information values of the two parts of CCs/BWPs are not completely the same.

Taking an example in which the first information configured in a case of multi-DCI scheduling is CORESETPoolIndex, in the CC group, a first part of CCs/BWPs each are configured with CORESETPoolIndex 0, CORESETPoolIndex 1 and CORESETPoolIndex 2. A second part of CCs/BWPs each are configured with CORESETPoolIndex 1, CORESETPoolIndex 3 and CORESETPoolIndex 4.

Optionally, (1) a target TCI state corresponding to the target TCI state ID in a target TCI state pool in the at least one TCI state pool is a unified TCI state of a target channel or a target reference signal corresponding to the target TCI state ID,
or
(2) a target TCI state corresponding to the target TCI state ID in a target TCI state pool in the at least one TCI state pool is a unified TCI state of a target channel or a target reference signal corresponding to first information corresponding to the target TCI state ID.

In this embodiment, the terminal determines a unified TCI state of a channel or a reference signal in a CC group based on the unified TCI state ID by the two methods described above. In (1) described above, when determining the unified TCI state of the channel or the reference signal based on the at least one unified TCI state ID, the terminal can select, based on a corresponding relationship between the unified TCI state ID and the channel/reference signal, a TCI state corresponding to the target TCI state ID from the target TCI state pool as a unified TCI state of the target channel/target reference signal corresponding to the target TCI state ID.

In (2) described above, when determining the unified TCI state of the channel or the reference signal based on the at least one unified TCI state ID, if the first information is configured, the terminal can select, based on a corresponding relationship between the unified TCI state ID, the first information and the channel/reference signal, a TCI state corresponding to the target TCI state ID from the target TCI state pool as a unified TCI state of the target channel/target reference signal corresponding to the first information corresponding to the target TCI state ID.

Optionally, the target state pool is: a TCI state pool corresponding to a target CC or a target BWP at which the target channel or the target reference signal is located,
or
the target state pool is: a TCI state pool corresponding to first information corresponding to the target channel or the target reference signal in a target CC or a target BWP at which the target channel or the target reference signal is located.

In this embodiment, when the terminal determines a TCI state of a channel or a reference signal based on an indicated or activated unified TCI state ID, a TCI state pool from which a unified TCI state is selected for the channel or the reference signal based on the unified TCI state ID needs to be determined. Since each CC or each BWP in the CC group has a corresponding TCI state pool, the TCI states corresponding to the same unified TCI state ID in different TCI state pools may be different. Therefore, the terminal needs to determine a target TCI state pool.

When the target TCI state pool is determined, a TCI state pool configured on a CC or BWP at which the target channel/target reference signal corresponding to the target TCI state ID is located may be used as the target TCI state pool, or the target TCI state pool can be determined based on configured first information, and a TCI state pool corresponding to the first information in the CC or BWP at which the target channel/target reference signal corresponding to the target TCI state ID is located may be used as the target TCI state pool. A TCI state corresponding to the target unified TCI state ID in the target TCI state pool is used as a unified TCI state of the target channel or the target reference signal.

If the network side device is configured with the first information, when the network side device activates or indicates a unified TCI state ID corresponding to a target value of the first information, a TCI state corresponding to the unified TCI state ID is determined as a unified TCI state of a channel/reference signal corresponding to the target value.

In this embodiment, when the unified TCI framework is applied in a multi-TRP scenario, a unified TCI state of channels on a group of carriers is determined based on the unified TCI state ID indicated or activated by the network side device, which can simplify signaling overheads of TCI state update in a CA scenario.

Optionally, the at least one unified TCI state ID is used to determine a unified TCI state of all channels or reference signals in the CC group. In this case, target signals or target reference signals associated with a target unified TCI state ID are all channels or reference signals in the CC group, that is, the unified TCI state of all the channels or reference signals is determined by the target unified TCI state ID. For example, all or part of unified TCI states of all the channels or reference signals in the CC group can be determined. For example, during repeated transmission or multi-beam transmission, the network side device may indicate only TCI states of part of the channels or the reference signals. For example, during repeated transmission or multi-beam transmission, unified TCI states determined by the target unified TCI ID can only be used as part of TCI states of such channels or reference signals. Above-mentioned all the channels or reference signals mean all channels or reference signals that always use or are configured to share unified TCI states in the CC group.

Alternatively,
a target unified TCI ID in the at least one unified TCI state ID is used to determine a unified TCI state of a target channel or a target reference signal corresponding to the target unified TCI state ID in the CC group. In this case, target signals or target reference signals associated with the target unified TCI state ID may be part of channels or reference signals in the CC group, that is, the unified TCI state of part of the channels or reference signals is determined by the target unified TCI state ID. For example, all or part of unified TCI states of target channels or target reference signals in the CC group can be determined. The above-mentioned part of the channels or reference signals mean channels or reference signals that always use or are configured to share unified TCI states in the CC group and are associated with the target unified TCI state ID.

In this embodiment, when a quantity of the at least one unified TCI state ID is one, it can be understood that all CCs/BWPs are single TRPs, or when there are a plurality of indicated TCI state IDs, it can be understood that all CCs/BWPs are multi-TRPs or at least one CC/BWP is a multi-TRP. Target signals or channels on all CCs/BWPs use indicated TCI states, or all or part of the indicated TCI states are used for each target signal or channel on each CC/BWP.

Optionally, in a case that the first information is configured, a unified TCI state ID activated or indicated by the first command corresponds to the first information. As there may be one or more indicated or activated unified TCI state IDs, there is one or more values of corresponding first information. The indicated unified TCI state ID is used to update TCI states of target signals corresponding to the first information on all CCs/BWPs in the CC group, that is, to determine common QCL information of a downlink target signal and/or a common UL TX spatial filter of an uplink target signal.

Optionally, the unified TCI state ID includes one of the following:
K joint TCI state IDs;
K pairs of separate TCI state IDs; and
K1 joint TCI state IDs and K2 pairs of separate TCI state IDs,
where K, K1 and K2 are all positive integers.

In this embodiment, the network side device can activate or indicate K joint TCI state IDs or K pairs of separate TCI state IDs or K1 joint TCI state IDs+K2 pairs of separate TCI state IDs. Correspondingly, it is understood as K TRPs or K1+K2 TRPs.

Each pair of separate TCI state IDs may be any of one DL TCI state ID and one UL TCI state ID, one DL TCI state ID, and one UL TCI state ID.

Optionally, at least one unified TCI state ID indicated by the first command each may correspond to one codepoint, or each TCI state ID in the indicated TCI state ID corresponds to one codepoint. Optionally, when the network side device activates a TCI state by a MAC CE, at least one codepoint corresponds to a plurality of joint TCI state IDs, or a plurality of pairs of separate TCI state IDs, or at least one joint TCI state ID and at least one pair of separate TCI state IDs.

Optionally, an effective time of the unified TCI state is determined based on a CC or BWP with a minimum SCS in sub-carrier spacings SCSs of all BWPs of CCs applying the unified TCI state in the CC group,
or
an effective time of the unified TCI state is determined based on a CC or BWP with a minimum SCS in SCSs of active BWPs of CCs applying the unified TCI state in the CC group.

In the embodiment of this application, the network side device indicates at least one unified TCI state ID through the first command, and determines a TCI state of a corresponding channel or reference signal based on the at least one unified TCI state ID. A CC/BWP applying the TCI state may be a CC/BWP configured with a first information value, all CCs/BWPs, or the like. When the TCI state is applied to BWPs, the BWPs may be all BWPs of all CCs, or active BWPs of all CCs, or all BWPs of CCs configured with a first information value, or active BWPs of CCs configured with a first information value, or all BWPs configured with a first information value, or active BWPs configured with a first information value.

In this embodiment, the effective time of the unified TCI state indicated by the network side device can be determined based on the CC/BWP with a minimum SCS in the CCs/BWPs applying the indicated TCI state. The BWPs may be all configured BWPs or all active BWPs in all CCs.

In the embodiment of this application, the network side device indicates or activates at least one unified TCI state ID through a first command. The unified TCI state ID is associated with a channel or a reference signal in a CC group. Based on the unified TCI state ID, the terminal can determine a TCI state of a group of channels or reference signals associated with the unified TCI state ID. This can be applied to beam information indication in a multi-TRP scenario, and simplify signaling overheads of unified TCI state update in a CA scenario.

In the beam information indication method according to the embodiment of this application, an executing subject may be a beam information indication apparatus. In the embodiment of this application, taking an example in which the beam information indication apparatus performs the beam information indication method, the beam information indication apparatus according to the embodiment of this application is described.

As shown in FIG. 4, an embodiment of this application provides a beam information indication apparatus 400, which is applied to a terminal and includes:
a first receiving module 410, configured to receive a first command sent by a network side device, the first command being used to activate or indicate at least one unified transmission configuration indicator TCI state ID; and
a first determining module 420, configured to determine a unified TCI state of a channel or a reference signal in a component carrier CC group based on the unified TCI state ID.

A target unified TCI state ID in the at least one unified TCI state ID is associated with a target channel or a target reference signal in the CC group.

Optionally, the apparatus further includes: a second receiving module, configured to receive a second command sent by the network side device. The second command is used to configure at least one TCI state pool for the terminal. The TCI state pool includes a unified TCI state corresponding to the unified TCI state ID.

Each CC or each BWP in the CC group has a corresponding TCI state pool.

Optionally, if configuration information of a first CC or a first BWP in the CC group includes first information, the first information is in a one-to-one correspondence with a TCI state pool corresponding to the first CC or the first BWP.

Optionally, configuration information of the TCI state pool is included in one of the following information:
configuration information of any CC in the CC group;
configuration information of any bandwidth part BWP in the CC group;
configuration information of a reference CC in the CC group; and
configuration information of a reference BWP in the CC group.

Optionally, if the configuration information of the TCI state pool is included in the configuration information of the reference CC in the CC group, configuration information of a second CC in the CC group includes indication information of the reference CC, and the configuration information of the second CC includes no configuration information of the TCI state pool, or
if the configuration information of the TCI state pool is included in the configuration information of the reference BWP in the CC group, configuration information of a second BWP in the CC group includes indication information of the reference BWP, and the configuration information of the second BWP includes no configuration information of the TCI state pool.

Optionally, the reference CC is one of the following CCs:
any CC in the CC group;
a CC configured with all first information in the CC group; and
a CC with first information configured as a target value in the CC group.

Optionally, the reference BWP is one of the following BWPs:
any BWP in the CC group;
a BWP configured with all first information in the CC group; and
a BWP with first information configured as a target value in the CC group.

Optionally, the first determining module is configured to
determine a unified TCI state of a target channel or a target reference signal corresponding to the target TCI state ID based on the target TCI state ID and a target TCI state pool in the at least one TCI state pool,
or
determine a unified TCI state of a target channel or a target reference signal corresponding to first information corresponding to the target TCI state ID based on the target TCI state ID and a target TCI state pool in the at least one TCI state pool.

Optionally, the apparatus further includes: a second determining module. The second determining module is configured to
determine the target TCI state pool based on a target CC or a target BWP at which the target channel or the target reference signal is located,
or
determine the target TCI state pool based on a target CC or a target BWP at which the target channel or the target reference signal is located, and the first information corresponding to the target channel or the target reference signal.

Optionally, that a target unified TCI state ID in the at least one unified TCI state ID is associated with a target channel or a target reference signal in the CC group includes the following:
The target unified TCI state ID has a corresponding relationship with the target channel or the target reference signal,
or
the target unified TCI state ID has a corresponding relationship with first information, and the first information has a corresponding relationship with the target channel or the target reference signal.

Optionally, the first information includes at least one of the following:
a CORESET ID;
a CORESET pool index;
a CORESET group ID;
an ID of interrelated SSs;
an ID of a CORESET at which interrelated SSs are located;
transmission opportunity information on interrelated SSs;
transmission time information on interrelated SSs;
a TRP ID;
a channel group ID;
a PUCCH resource group ID;
a PCI; or
a terminal panel ID.

Optionally, the first information is configured in one of the following information:
configuration information of a CC in the CC group;
configuration information of a BWP in the CC group; and
configuration information of a cell group in which the CC group is located.

Optionally, a method for configuring the first information includes one of the following:
all CCs or all BWPs in the same CC group are configured with the same first information;
in the CC group, a first part of CCs or a first part of BWPs each are configured with one piece of first information, and a second part of CCs or a second part of BWPs each are configured with at least two pieces of first information;
in the CC group, a first part of CCs or a first part of BWPs and a second part of CCs or a second part of BWPs each are configured with one piece of first information, and the first information that the first part of CCs or the first part of BWPs are configured with is different from the first information that the second part of CCs or the second part of BWPs are configured with; and
in the CC group, a first part of CCs or a first part of BWPs and a second part of CCs or a second part of BWPs each are configured with at least two pieces of first information, and the first information that the first part of CCs or the first part of BWPs are configured with is at least partially different from the first information that the second part of CCs or the second part of BWPs are configured with.

Optionally, the first determining module is configured to
determine a unified TCI state of all channels or reference signals in the CC group based on the at least one unified TCI state ID,
or
determine a unified TCI state of a target channel or a target reference signal corresponding to the target unified TCI state ID in the CC group based on a target unified TCI ID in the at least one unified TCI state ID.

Optionally, the unified TCI state ID includes one of the following:
K joint TCI state IDs;
K pairs of separate TCI state IDs; and
K1 joint TCI state IDs and K2 pairs of separate TCI state IDs,
where K, K1 and K2 are all positive integers.

Optionally, the apparatus further includes: a third determining module. The third determining module is configured to
determine an effective time of the unified TCI state based on a CC or BWP with a minimum SCS in sub-carrier spacings SCSs of all BWPs of CCs applying the unified TCI state in the CC group,
or
determine an effective time of the unified TCI state based on a CC or BWP with a minimum SCS in SCSs of active BWPs of CCs applying the unified TCI state in the CC group.

In the embodiment of this application, the network side device indicates or activates at least one unified TCI state ID through a first command. The unified TCI state ID is associated with a channel or a reference signal in a CC group. Based on the unified TCI state ID, the terminal can determine a TCI state of a group of channels or reference signals associated with the unified TCI state ID. This can be applied to beam information indication in a multi-TRP scenario, and simplify signaling overheads of unified TCI state update in a CA scenario.

The beam information indication apparatus according to the embodiment of this application can implement each process implemented in the method embodiment of FIG. 2, and achieve the same technical effect. To avoid repetition, details are not described herein.

As shown in FIG. 5, an embodiment of this application provides a beam information indication apparatus 500, which is applied to a network side device and includes:
a first sending module 510, configured to send a first command to a terminal. The first command is used to activate or indicate at least one unified TCI state ID. The unified TCI state ID is used to determine a TCI state of a channel or a reference signal in a CC group.

A target unified TCI state ID in the at least one unified TCI state ID is associated with a target channel or a target reference signal in the CC group.

Optionally, the apparatus further includes: a second sending module, configured to send a second command to the terminal. The second command is used to configure at least one TCI state pool for the terminal. The TCI state pool includes a unified TCI state corresponding to the unified TCI state ID.

Each CC or each BWP in the CC group has a corresponding TCI state pool.

Optionally, if configuration information of a first CC or a first BWP in the CC group includes first information, the first information is in a one-to-one correspondence with a TCI state pool corresponding to the first CC or the first BWP.

Optionally, configuration information of the TCI state pool is configured in one of the following information:
configuration information of any CC in the CC group;
configuration information of any BWP in the CC group;
configuration information of a reference CC in the CC group; and
configuration information of a reference BWP in the CC group.

Optionally, if the configuration information of the TCI state pool is included in the configuration information of the reference CC in the CC group, configuration information of a second CC in the CC group includes indication information of the reference CC, and the configuration information of the second CC includes no configuration information of the TCI state pool, or
if the configuration information of the TCI state pool is included in the configuration information of the reference BWP in the CC group, configuration information of a second BWP in the CC group includes indication information of the reference BWP, and the configuration information of the second BWP includes no configuration information of the TCI state pool.

Optionally, the reference CC is one of the following CCs:
any CC in the CC group;
a CC configured with all first information in the CC group; and
a CC with first information configured as a target value in the CC group.

Optionally, the reference BWP is one of the following BWPs:
any BWP in the CC group;
a BWP configured with all first information in the CC group; and
a BWP with first information configured as a target value in the CC group.

Optionally, a target TCI state corresponding to the target TCI state ID in a target TCI state pool in the at least one TCI state pool is a unified TCI state of a target channel or a target reference signal corresponding to the target TCI state ID,
or
a target TCI state corresponding to the target TCI state ID in a target TCI state pool in the at least one TCI state pool is a unified TCI state of a target channel or a target reference signal corresponding to first information corresponding to the target TCI state ID.

Optionally, the target state pool is: a TCI state pool corresponding to a target CC or a target BWP at which the target channel or the target reference signal is located,
or
the target state pool is: a TCI state pool corresponding to first information corresponding to the target channel or the target reference signal in a target CC or a target BWP at which the target channel or the target reference signal is located.

Optionally, that a target unified TCI state ID in the at least one unified TCI state ID is associated with a target channel or a target reference signal in the CC group includes the following:
the target unified TCI state ID has a corresponding relationship with the target channel or the target reference signal,
or
the target unified TCI state ID has a corresponding relationship with first information, and the first information has a corresponding relationship with the target channel or the target reference signal.

Optionally, the first information includes at least one of the following:
a CORESET ID;
a CORESET pool index;
a CORESET group ID;
an ID of interrelated search spaces SSs;
an ID of a CORESET at which interrelated SSs are located;
transmission opportunity information on interrelated SSs;
transmission time information on interrelated SSs;
a TRP ID;
a channel group ID;
a PUCCH resource group ID;
a physical cell identifier PCI; or
a terminal panel ID.

Optionally, the first information is configured in one of the following information:
configuration information of a CC in the CC group;
configuration information of a BWP in the CC group; and
configuration information of a cell group in which the CC group is located.

Optionally, a method for configuring the first information includes one of the following:
all CCs or all BWPs in the same CC group are configured with the same first information;
in the CC group, a first part of CCs or a first part of BWs each are configured with one piece of first information, and a second part of CCs or a second part of BWPs each are configured with at least two pieces of first information;
in the CC group, a first part of CCs or a first part of BWPs and a second part of CCs or a second part of BWPs each are configured with one piece of first information, and the first information that the first part of CCs or the first part of BWPs are configured with is different from the first information that the second part of CCs or the second part of BWPs are configured with; and
in the CC group, a first part of CCs or a first part of BWPs and a second part of CCs or a second part of BWPs each are configured with at least two pieces of first information, and the first information that the first part of CCs or the first part of BWPs are configured with is at least partially different from the first information that the second part of CCs or the second part of BWPs are configured with.

Optionally, the at least one unified TCI state ID is used to determine a unified TCI state of all channels or reference signals in the CC group,
or
a target unified TCI ID in the at least one unified TCI state ID is used to determine a unified TCI state of a target channel or a target reference signal corresponding to the target unified TCI state ID in the CC group.

Optionally, the unified TCI state ID includes one of the following:
K joint TCI state IDs;
K pairs of separate TCI state IDs; and
K1 joint TCI state IDs and K2 pairs of separate TCI state IDs,
where K, K1 and K2 are all positive integers.

Optionally, an effective time of the unified TCI state is determined based on a CC or BWP with a minimum SCS in sub-carrier spacings SCSs of all BWPs of CCs applying the unified TCI state in the CC group,
or
an effective time of the unified TCI state is determined based on a CC or BWP with a minimum SCS in SCSs of active BWPs of CCs applying the unified TCI state in the CC group.

In the embodiment of this application, the network side device indicates or activates at least one unified TCI state ID through a first command. The unified TCI state ID is associated with a channel or a reference signal in a CC group. Based on the unified TCI state ID, the terminal can determine a TCI state of a group of channels or reference signals associated with the unified TCI state ID. This can be applied to beam information indication in a multi-TRP scenario, and simplify signaling overheads of unified TCI state update in a CA scenario.

The beam information indication apparatus according to the embodiment of this application can implement each process implemented in the method embodiment of FIG. 3, and achieve the same technical effect. To avoid repetition, details are not described herein.

The beam information indication apparatus in the embodiment of this application may be an electronic device, such as an electronic device with an operating system, or a component in the electronic device, such as an integrated circuit or a chip. The electronic device may be a terminal or another device other than the terminal. For example, the terminal may include, but is not limited to, the types of the terminal 11 listed above, and the another device may be a server, a network attached storage (NAS), and the like, which is not specifically limited in the embodiment of this application.

Optionally, as shown in FIG. 6, an embodiment of this application further provides a communication device 600, including a processor 601 and a memory 602. The memory 602 stores a program or instructions that can be run on the processor 601. For example, when the communication device 600 is a terminal, and when the program or instructions are executed by the processor 601, each step of the above-mentioned beam information indication method embodiment applied to the terminal is implemented, which can achieve the same technical effect. When the communication device 600 is a network side device, and when the program or instructions are executed by the processor 601, each step of the above-mentioned beam information indication method embodiment applied to the network side device is implemented, which can achieve the same technical effect. To avoid repetition, details are not described herein.

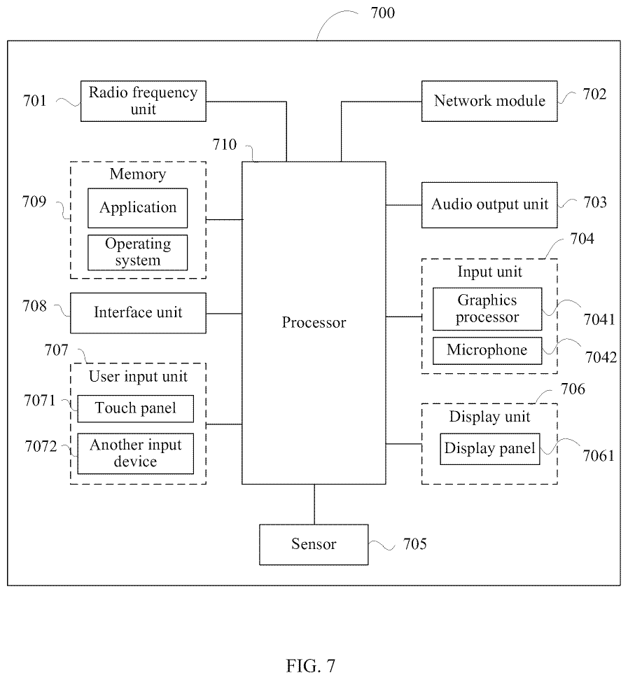

An embodiment of this application further provides a terminal, including a processor and a communication interface. The communication interface is configured to receive a first command sent by a network side device. The first command is used to activate or indicate at least one unified transmission configuration indicator TCI state ID. The processor is configured to determine a unified TCI state of a channel or a reference signal in a component carrier CC group based on the unified TCI state ID. A target unified TCI state ID in the at least one unified TCI state ID is associated with a target channel or a target reference signal in the CC group. The terminal embodiment corresponds to the above-mentioned terminal side method embodiment, and each implementation process and implementation of the above-mentioned method embodiment can be applied to the terminal embodiment, which can achieve the same technical effect. For example, FIG. 7 is a schematic diagram of a hardware structure of a terminal according to an embodiment of this application.

The terminal 700 includes, but is not limited to, at least some components of a radio frequency unit 701, a network module 702, an audio output unit 703, an input unit 704, a sensor 705, a display unit 706, a user input unit 707, an interface unit 708, a memory 709 and a processor 710.

It can be understood by a person skilled in the art that the terminal 700 may further include a power supply (such as a battery) for supplying power to various components. The power supply may be logically connected to the processor 710 by a power management system, so as to achieve charging, discharging, power consumption management and other functions by the power management system. The terminal structure shown in FIG. 7 does not constitute a limitation to the terminal. The terminal may include more or fewer components than those shown, or combine some components, or have different component arrangements. Details are not described herein.

It should be understood that in the embodiment of this application, the input unit 704 may include a graphics processing unit (GPU) 7041 and a microphone 7042. The graphics processing unit 7041 processes image data of a static picture or a video that is obtained by an image acquisition apparatus (for example, a camera) in a video acquisition mode or an image acquisition mode. The display unit 706 may include a display panel 7061, and the display panel 7061 may be configured in the form of a liquid crystal display, an organic light emitting diode, or the like. The user input unit 707 includes at least one of a touch panel 7071 or another input device 7072. The touch panel 7071 is also referred to as a touch screen. The touch panel 7071 may include two parts: a touch detection apparatus and a touch controller. The another input device 7072 may include, but is not limited to, a physical keyboard, a functional key (such as a volume control key or a switch key), a track ball, a mouse, and a joystick, which is not described in detail herein.

In the embodiment of this application, after receiving downlink data from a network side device, the radio frequency unit 701 may transmit the data to the processor 710 for processing. In addition, the radio frequency unit 701 may send uplink data to the network side device. Generally, the radio frequency unit 701 includes, but is not limited to, an antenna, an amplifier, a transceiver, a coupler, a low noise amplifier and a duplexer.

The memory 709 may be configured to store a software program or instructions and various data. The memory 709 may mainly include a first storage area for storing a program or instructions and a second storage area for storing data, where the first storage area may store an operating system, an application or instructions required for at least a function (such as a sound playing function and an image playing function), and the like. In addition, the memory 709 may include a volatile memory or a non-volatile memory, or the memory 709 may include a volatile memory and a non-volatile memory. The non-volatile memory may be a read-only memory (ROM), a programmable ROM (PROM), an erasable PROM (EPROM), an electrically EPROM (EEPROM) or a flash memory. The volatile memory may be a random access memory (RAM), a static RAM (SRAM), a dynamic RAM (DRAM), a synchronous DRAM (SDRAM), a double data rate SDRAM (DDRSDRAM), an enhanced SDRAM (ESDRAM), a synchronous link DRAM (SLDRAM), and a direct Rambus RAM (DRRAM). The memory 709 in the embodiment of this application includes, but is not limited to, these and any other suitable types of memories.

The processor 710 may include one or more processing units. Optionally, the processor 710 integrates an application processor and a modem processor, where the application processor mainly deals with operations involving an operating system, a user interface, an application program, and the like, and the modem processor mainly processes wireless communication signals, such as a baseband processor. It can be understood that, the modem processor may not be integrated into the processor 710.

The radio frequency unit 701 is configured to receive a first command sent by a network side device. The first command is used to activate or indicate at least one unified transmission configuration indicator TCI state ID.

The processor 710 is configured to determine a unified TCI state of a channel or a reference signal in a component carrier CC group based on the unified TCI state ID.

A target unified TCI state ID in the at least one unified TCI state ID is associated with a target channel or a target reference signal in the CC group.

Optionally, the radio frequency unit 701 is further configured to receive a second command sent by the network side device. The second command is used to configure at least one TCI state pool for the terminal. The TCI state pool includes a unified TCI state corresponding to the unified TCI state ID.

Each CC or each BWP in the CC group has a corresponding TCI state pool.

Optionally, if configuration information of a first CC or a first BWP in the CC group includes first information, the first information is in a one-to-one correspondence with a TCI state pool corresponding to the first CC or the first BWP.

Optionally, configuration information of the TCI state pool is included in one of the following information:
configuration information of any CC in the CC group;
configuration information of any bandwidth part BWP in the CC group;
configuration information of a reference CC in the CC group; and
configuration information of a reference BWP in the CC group.

Optionally, if the configuration information of the TCI state pool is included in the configuration information of the reference CC in the CC group, configuration information of a second CC in the CC group includes indication information of the reference CC, and the configuration information of the second CC includes no configuration information of the TCI state pool, or
if the configuration information of the TCI state pool is included in the configuration information of the reference BWP in the CC group, configuration information of a second BWP in the CC group includes indication information of the reference BWP, and the configuration information of the second BWP includes no configuration information of the TCI state pool.

Optionally, the reference CC is one of the following CCs:
any CC in the CC group;
a CC configured with all first information in the CC group; and
a CC with first information configured as a target value in the CC group.

Optionally, the reference BWP is one of the following BWPs:
any BWP in the CC group;
a BWP configured with all first information in the CC group; and
a BWP with first information configured as a target value in the CC group.

Optionally, the processor 710 is further configured to
determine a unified TCI state of a target channel or a target reference signal corresponding to the target TCI state ID based on the target TCI state ID and a target TCI state pool in the at least one TCI state pool,
or
determine a unified TCI state of a target channel or a target reference signal corresponding to first information corresponding to the target TCI state ID based on the target TCI state ID and a target TCI state pool in the at least one TCI state pool.

Optionally, the processor 710 is further configured to
determine the target TCI state pool based on a target CC or a target BWP at which the target channel or the target reference signal is located,
or
determine the target TCI state pool based on a target CC or a target BWP at which the target channel or the target reference signal is located, and the first information corresponding to the target channel or the target reference signal.

Optionally, that a target unified TCI state ID in the at least one unified TCI state ID is associated with a target channel or a target reference signal in the CC group includes the following:
the target unified TCI state ID has a corresponding relationship with the target channel or the target reference signal,
or
the target unified TCI state ID has a corresponding relationship with first information, and the first information has a corresponding relationship with the target channel or the target reference signal.

Optionally, the first information includes at least one of the following:
a CORESET ID;
a CORESET pool index;
a CORESET group ID;
an ID of interrelated SSs;
an ID of a CORESET at which interrelated SSs are located;
transmission opportunity information on interrelated SSs;
transmission time information on interrelated SSs;
a TRP ID;
a channel group ID;
a PUCCH resource group ID;
a PCI; or
a terminal panel ID.

Optionally, the first information is configured in one of the following information:
configuration information of a CC in the CC group;
configuration information of a BWP in the CC group; and
configuration information of a cell group in which the CC group is located.

Optionally, a method for configuring the first information includes one of the following:
all CCs or all BWPs in the same CC group are configured with the same first information;
in the CC group, a first part of CCs or a first part of BWPs each are configured with one piece of first information, and a second part of CCs or a second part of BWPs each are configured with at least two pieces of first information;
in the CC group, a first part of CCs or a first part of BWPs and a second part of CCs or a second part of BWPs each are configured with one piece of first information, and the first information that the first part of CCs or the first part of BWPs are configured with is different from the first information that the second part of CCs or the second part of BWPs are configured with; and
in the CC group, a first part of CCs or a first part of BWPs and a second part of CCs or a second part of BWPs each are configured with at least two pieces of first information, and the first information that the first part of CCs or the first part of BWPs are configured with is at least partially different from the first information that the second part of CCs or the second part of BWPs are configured with.

Optionally, the processor 710 is further configured to
determine, by the terminal, a unified TCI state of all channels or reference signals in the CC group based on the at least one unified TCI state ID,
or
determine, by the terminal, a unified TCI state of a target channel or a target reference signal corresponding to the target unified TCI state ID in the CC group based on a target unified TCI ID in the at least one unified TCI state ID.

Optionally, the unified TCI state ID includes one of the following:
K joint TCI state IDs;
K pairs of separate TCI state IDs; and
K1 joint TCI state IDs and K2 pairs of separate TCI state IDs,
where K, K1 and K2 are all positive integers.

Optionally, the processor 710 is further configured to
determine an effective time of the unified TCI state based on a CC or BWP with a minimum SCS in sub-carrier spacings SCSs of all BWPs of CCs applying the unified TCI state in the CC group,
or
determine an effective time of the unified TCI state based on a CC or BWP with a minimum SCS in SCSs of active BWPs of CCs applying the unified TCI state in the CC group.

In the embodiment of this application, the network side device indicates or activates at least one unified TCI state ID through a first command. The unified TCI state ID is associated with a channel or a reference signal in a CC group. Based on the unified TCI state ID, the terminal can determine a TCI state of a group of channels or reference signals associated with the unified TCI state ID. This can be applied to beam information indication in a multi-TRP scenario, and simplify signaling overheads of unified TCI state update in a CA scenario.

An embodiment of this application further provides a network side device, including a processor and a communication interface. The communication interface is configured to send a first command to a terminal. The first command is used to activate or indicate at least one unified TCI state ID. The unified TCI state ID is used to determine a TCI state of a channel or a reference signal in a CC group. A target unified TCI state ID in the at least one unified TCI state ID is associated with a target channel or a target reference signal in the CC group. The network side device embodiment corresponds to the above-mentioned method embodiment for the network side device, and each implementation process and implementation of the above-mentioned method embodiment can be applied to the network side device embodiment, which can achieve the same technical effect.

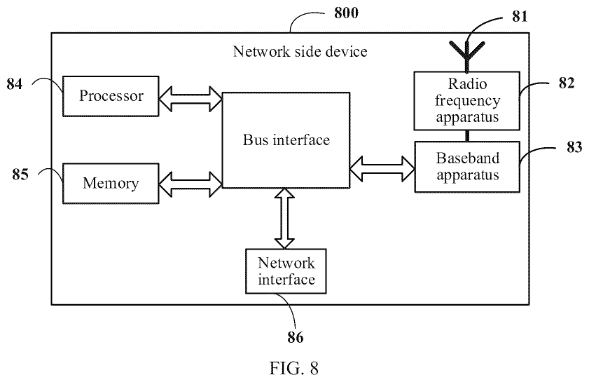

Optionally, an embodiment of this application further provides a network side device. As shown in FIG. 8, the network side device 800 includes: an antenna 81, a radio frequency apparatus 82, a baseband apparatus 83, a processor 84 and a memory 85. The antenna 81 is connected to the radio frequency apparatus 82. In an uplink direction, the radio frequency apparatus 82 receives information through the antenna 81 and sends the received information to the baseband apparatus 83 for processing. In a downlink direction, the baseband apparatus 83 processes information to be sent and sends processed information to the radio frequency apparatus 82. The radio frequency apparatus 82 processes the received information and sends processed information through the antenna 81.

The method performed by the network side device in the above embodiment can be implemented in the baseband apparatus 83. The baseband apparatus 83 includes a baseband processor.

For example, the baseband apparatus 83 may include at least one baseband board, and a plurality of chips are arranged on the baseband board. As shown in FIG. 8, one of the chips is, for example, a baseband processor, and is connected to the memory 85 through a bus interface, so as to invoke a program in the memory 85 to perform an operation of the network side device shown in the above method embodiment.

The network side device may further include a network interface 86. The interface is, for example, a common public radio interface (CPRI).

Optionally, the network side device 800 according to the embodiment of the present application further includes: instructions or a program that is stored in the memory 85 and can be run on the processor 84. The processor 84 invokes the instructions or program in the memory 85 to perform the method performed by each module shown in FIG. 5, to achieve the same technical effect. To avoid repetition, details are not described herein.

An embodiment of this application further provides a non-transitory readable storage medium. The non-transitory readable storage medium stores a program or instructions. When the program or instructions are executed by a processor, each process of the above-mentioned beam information indication method embodiment is implemented, which can achieve the same technical effect. To avoid repetition, details are not described herein.

The processor is the processor in the terminal in the above embodiment. The non-transitory readable storage medium includes a non-transitory computer-readable storage medium, such as computer read-only memory ROM, a random access memory RAM, a magnetic disk or a compact disc.

An embodiment of this application further provides a chip. The chip includes a processor and a communication interface. The communication interface is coupled to the processor, and the processor is configured to run a program or instructions to implement each process of the above-mentioned beam information indication method embodiment, which can achieve the same technical effect. To avoid repetition, details are not described herein.

It should be understood that the chip mentioned in the embodiment of this application may be also referred to as a system-on-a-chip, a system on a chip, a system-on-chip, a system on chip, or the like.

An embodiment of this application further provides a computer program/program product. The computer program/program product is stored on a non-transitory storage medium. The computer program/program product is executed by at least one processor to implement each process of the above-mentioned beam information indication method embodiment, which can achieve the same technical effect. To avoid repetition, details are not described herein.

An embodiment of this application further provides a communication system, including: a terminal and a network side device. The terminal may be configured to perform the steps of the above-mentioned beam information indication method applied to the terminal. The network side device may be configured to perform the steps of the above-mentioned beam information indication method applied to the network side device.

It should be noted that herein, terms “including”, “comprising” or any other variants thereof are intended to cover non-exclusive inclusion, so that a process, method, article or apparatus including a series of elements includes not only those elements but also other elements not explicitly listed, or elements inherent to such a process, method, article or apparatus. Without further limitation, an element defined by the phrase “including a . . . ” does not exclude the presence of an additional identical element in the process, method, article or apparatus including the element. In addition, it should be noted that the scope of the method and apparatus in the implementations of this application is not limited to performing functions in the order shown or discussed, but also can include performing functions in a substantially simultaneous manner or in a reverse order based on the functions involved. For example, the described method can be performed in an order different from that described, and various steps can be added, omitted or combined. In addition, features described with reference to some examples can be combined in other examples.

By the description of the above implementations, a person skilled in the art can clearly understand that the method in the foregoing embodiments may be implemented by software and a necessary general-purpose hardware platform, or certainly, by hardware. Based on this understanding, the technical solution of this application essentially, or a part contributing to the prior art, may be embodied in a form of a computer software product. The computer software product is stored on a non-transitory storage medium (for example, an ROM/RAM, a magnetic disk and a compact disc), and includes a plurality of instructions to cause a terminal (which may be a mobile phone, a computer, a server, an air-conditioner, a network device, or the like) to perform the method according to each embodiment of this application.

The embodiments of this application are described above with reference to the accompanying drawings, but this application is not limited to the implementations described above, and the implementations described above are merely illustrative and not restrictive. A person of ordinary skill in the art may further make many forms under the teaching of this application without departing from the purpose of this application and the protection scope of the claims, and these forms all fall within the protection scope of this application.

What is claimed is:

1. A beam information indication method, comprising:
receiving, by a terminal, a first command sent by a network side device, the first command being used to activate or indicate at least one unified transmission configuration indicator (TCI) state identifier (ID); and
determining, by the terminal, a unified TCI state of a channel or a reference signal in a component carrier (CC) group based on the unified TCI state ID,
wherein a target unified TCI state ID in the at least one unified TCI state ID is associated with a target channel or a target reference signal in the CC group.

2. The method according to claim 1, wherein the method further comprises:
receiving, by the terminal, a second command sent by the network side device, the second command being used to configure at least one TCI state pool for the terminal; and the TCI state pool comprising a unified TCI state corresponding to the unified TCI state ID,
wherein each CC or each bandwidth part (BWP) in the CC group has a corresponding TCI state pool.

3. The method according to claim 2, wherein if configuration information of a first CC or a first BWP in the CC group comprises first information, the first information is in a one-to-one correspondence with a TCI state pool corresponding to the first CC or the first BWP.

4. The method according to claim 2, wherein the determining, by the terminal, a unified TCI state of a channel or a reference signal in a CC group based on the TCI state ID comprises:
determining a unified TCI state of a target channel or a target reference signal corresponding to the target TCI state ID based on the target TCI state ID and a target TCI state pool in the at least one TCI state pool,
or
determining a unified TCI state of a target channel or a target reference signal corresponding to first information corresponding to the target TCI state ID based on the target TCI state ID and a target TCI state pool in the at least one TCI state pool.

5. The method according to claim 4, wherein the method further comprises:
determining the target TCI state pool based on a target CC or a target BWP at which the target channel or the target reference signal is located,
or
determining the target TCI state pool based on a target CC or a target BWP at which the target channel or the target reference signal is located, and the first information corresponding to the target channel or the target reference signal.

6. The method according to claim 1, wherein that a target unified TCI state ID in the at least one unified TCI state ID is associated with a target channel or a target reference signal in the CC group comprises that
the target unified TCI state ID has a corresponding relationship with the target channel or the target reference signal,
or
the target unified TCI state ID has a corresponding relationship with first information, and the first information has a corresponding relationship with the target channel or the target reference signal.

7. The method according to claim 3, wherein the first information comprises at least one of the following:
a control resource set (CORESET) ID;
a CORESET pool index;
a CORESET group ID;
an ID of interrelated search spaces (SSs);
an ID of a CORESET at which interrelated SSs are located;
transmission opportunity information on interrelated SSs;
transmission time information on interrelated SSs;
a transmission-reception point (TRP) ID;
a channel group ID;
a physical uplink control channel (PUCCH) resource group ID;
a physical cell identifier (PCI); or
a terminal panel ID.

8. The method according to claim 3, wherein a method for configuring the first information comprises one of the following:
all CCs or all BWPs in the same CC group are configured with the same first information;
in the CC group, a first part of CCs or a first part of BWPs each are configured with one piece of first information, and a second part of CCs or a second part of BWPs each are configured with at least two pieces of first information;
in the CC group, a first part of CCs or a first part of BWPs and a second part of CCs or a second part of BWPs each are configured with one piece of first information, and the first information that the first part of CCs or the first part of BWPs are configured with is different from the first information that the second part of CCs or the second part of BWPs are configured with; and
in the CC group, a first part of CCs or a first part of BWPs and a second part of CCs or a second part of BWPs each are configured with at least two pieces of first information, and the first information that the first part of CCs or the first part of BWPs are configured with is at least partially different from the first information that the second part of CCs or the second part of BWPs are configured with.

9. A beam information indication method, comprising:
sending, by a network side device, a first command to a terminal, the first command being used to activate or indicate at least one unified transmission configuration indicator (TCI) state identifier (ID); and the unified TCI state ID being used to determine a TCI state of a channel or a reference signal in a component carrier (CC) group,
wherein a target unified TCI state ID in the at least one unified TCI state ID is associated with a target channel or a target reference signal in the CC group.

10. The method according to claim 9, wherein the method further comprises:
sending, by the network side device, a second command to the terminal, the second command being used to configure at least one TCI state pool for the terminal; and the TCI state pool comprising a unified TCI state corresponding to the unified TCI state ID,
wherein each CC or each bandwidth part (BWP) in the CC group has a corresponding TCI state pool.

11. The method according to claim 10, wherein if configuration information of a first CC or a first BWP in the CC group comprises first information, the first information is in a one-to-one correspondence with a TCI state pool corresponding to the first CC or the first BWP.

12. The method according to claim 10, wherein a target TCI state corresponding to the target TCI state ID in a target TCI state pool in the at least one TCI state pool is a unified TCI state of a target channel or a target reference signal corresponding to the target TCI state ID,
or
a target TCI state corresponding to the target TCI state ID in a target TCI state pool in the at least one TCI state pool is a unified TCI state of a target channel or a target reference signal corresponding to first information corresponding to the target TCI state ID.

13. The method according to claim 12, wherein the target state pool is: a TCI state pool corresponding to a target CC or a target BWP at which the target channel or the target reference signal is located,
or
the target state pool is: a TCI state pool corresponding to first information corresponding to the target channel or the target reference signal in a target CC or a target BWP at which the target channel or the target reference signal is located.

14. The method according to claim 9, wherein that a target unified TCI state ID in the at least one unified TCI state ID is associated with a target channel or a target reference signal in the CC group comprises that
the target unified TCI state ID has a corresponding relationship with the target channel or the target reference signal,
or
the target unified TCI state ID has a corresponding relationship with first information, and the first information has a corresponding relationship with the target channel or the target reference signal.

15. The method according to claim 11, wherein the first information comprises at least one of the following:
a control resource set (CORESET) ID;
a CORESET pool index;
a CORESET group ID;
an ID of interrelated search spaces (SSs);
an ID of a CORESET at which interrelated SSs are located;
transmission opportunity information on interrelated SSs;
transmission time information on interrelated SSs;
a transmission-reception point (TRP) ID;
a channel group ID;
a physical uplink control channel (PUCCH) resource group ID;
a physical cell identifier (PCI); or
a terminal panel ID.

16. The method according to claim 11, wherein a method for configuring the first information comprises one of the following:
all CCs or all BWPs in the same CC group are configured with the same first information;
in the CC group, a first part of CCs or a first part of BWPs each are configured with one piece of first information, and a second part of CCs or a second part of BWPs each are configured with at least two pieces of first information;
in the CC group, a first part of CCs or a first part of BWPs and a second part of CCs or a second part of BWPs each are configured with one piece of first information, and the first information that the first part of CCs or the first part of BWPs are configured with is different from the first information that the second part of CCs or the second part of BWPs are configured with; and
in the CC group, a first part of CCs or a first part of BWPs and a second part of CCs or a second part of BWPs each are configured with at least two pieces of first information, and the first information that the first part of CCs or the first part of BWPs are configured with is at least partially different from the first information that the second part of CCs or the second part of BWPs are configured with.

17. A terminal, comprising a processor and a memory, wherein the memory stores a program or instructions capable of being run on the processor, and the program or instructions, when executed by the processor, cause the terminal to perform:
receiving a first command sent by a network side device, the first command being used to activate or indicate at least one unified transmission configuration indicator (TCI) state identifier (ID); and
determining a unified TCI state of a channel or a reference signal in a component carrier (CC) group based on the unified TCI state ID,
wherein a target unified TCI state ID in the at least one unified TCI state ID is associated with a target channel or a target reference signal in the CC group.

18. The terminal according to claim 17, wherein the program or instructions, when executed by the processor, cause the terminal to further perform:
receiving a second command sent by the network side device, the second command being used to configure at least one TCI state pool for the terminal; and the TCI state pool comprising a unified TCI state corresponding to the unified TCI state ID,
wherein each CC or each bandwidth part (BWP) in the CC group has a corresponding TCI state pool.

19. The terminal according to claim 18, wherein if configuration information of a first CC or a first BWP in the CC group comprises first information, the first information is in a one-to-one correspondence with a TCI state pool corresponding to the first CC or the first BWP.

20. A network side device, comprising a processor and a memory, the memory storing a program or instructions capable of being run on the processor, and when the program or instructions are executed by the processor, the steps of the beam information indication method according to claim 9 being implemented.
